(19) United States
(12) Patent Application Publication
(10) Pub. No.: US 2026/0208484 A1
(43) Pub. Date: Jul. 23, 2026

(54) LIQUID EJECTION HEAD

(71) Applicant: CANON KABUSHIKI KAISHA, Tokyo (JP)

(72) Inventors: SAORI NARUKAWA, Kanagawa (JP); KEIJI TOMIZAWA, Kanagawa (JP); TAKATSUGU MORIYA, Tokyo (JP); YOSHIHIRO HAMADA, Kanagawa (JP)

(21) Appl. No.: 19/440,751

(22) Filed: Jan. 6, 2026

(30) Foreign Application Priority Data
Jan. 22, 2025 (JP) 2025-009010

(51) Int. Cl. B41J 2/14

(52) U.S. Cl. CPC B41J 2/1404; B41J 2/14145; B41J 2/14201; B41J 2/1433; B41J 2002/14306; B41J 2002/14419

(57) ABSTRACT

Provided is a liquid ejection head including: a plurality of ejection ports arranged side by side in a specified arrangement direction; a plurality of individual liquid chambers, the plurality of individual liquid chambers being in communication with the ejection ports; an energy generation element; a common liquid chamber that is in communication with the plurality of individual liquid chambers; and a supply port being in communication with the common liquid chamber. In a case where, in the arrangement direction, one end of the liquid ejection head is defined as a first end and the other end thereof is defined as a second end, and an individual liquid chamber closest to the first end among the plurality of individual liquid chambers is defined as a first individual liquid chamber, the supply port is located closer to the first end than the first individual liquid chamber.

### BACKGROUND

### Field of the Technology

The present disclosure relates to a liquid ejection head.

### Description of the Related Art

Hitherto, liquid ejection heads such as inkjet heads have been known in which driving elements (energy generation elements) such as piezoelectric elements or electrothermal converting elements are driven to discharge liquid on the basis of pressure or air bubble generation. Japanese Patent Application Laid-open No. 2024-93775 discloses a configuration in which a liquid can be supplied from a plurality of supply ports (independent ports) to most of the ejection ports (nozzles) in an ejection port row having a plurality of ejection ports arranged.

However, in the above-described configuration, when suction recovery using a cap or a recovery operation based on the preliminary ejection of the driving elements is performed, the liquid can be supplied only from a single supply port to an ejection port arranged at an end of the ejection port row. If the amount of the liquid supplied during the recovery operation is insufficient, nozzle clogging may occur, potentially leading to a reduction in printing quality.

### SUMMARY

In view of the above problem, it is an object of the present disclosure to provide a liquid ejection head capable of preventing a reduction in printing quality.

In order to achieve the above-described object, the present disclosure provides a liquid ejection head for ejecting a liquid toward a recording medium, the liquid ejection head including:

a plurality of ejection ports that eject the liquid, the plurality of ejection ports being arranged side by side in a specified arrangement direction;

a plurality of individual liquid chambers provided corresponding to the plurality of ejection ports, respectively, the plurality of individual liquid chambers being in communication with the ejection ports;

an energy generation element that generates energy for ejecting the liquid from the ejection ports, the energy generation element being provided for each of the plurality of individual liquid chambers;

a common liquid chamber that is in communication with the plurality of individual liquid chambers; and

a supply port that supplies the liquid to the individual liquid chambers via the common liquid chamber, the supply port being in communication with the common liquid chamber,

wherein, in a case where, in the arrangement direction, one end of the liquid ejection head is defined as a first end and the other end thereof is defined as a second end, and an individual liquid chamber closest to the first end among the plurality of individual liquid chambers is defined as a first individual liquid chamber, the supply port is located closer to the first end than the first individual liquid chamber.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating the schematic configuration of a recording device.

FIG. 2 is a perspective view illustrating the schematic configuration of a printing head.

FIG. 3 is a cross-sectional view of a liquid ejection substrate.

FIG. 4 is a view illustrating an overview of a first embodiment.

FIG. 5 is a view illustrating an overview of a first comparative example.

FIGS. 6A and 6B are explanatory views illustrating a liquid flow during a recovery operation in the first embodiment and the first comparative example, FIG. 6A being a schematic view illustrating the liquid flow in the first comparative example, FIG. 6B being a schematic view illustrating the liquid flow in the first embodiment.

FIG. 7 is a view illustrating an overview of a second embodiment.

FIG. 8 is a view illustrating an overview of a third embodiment.

FIG. 9 is a view illustrating an overview of a second comparative example.

FIGS. 10A and 10B are explanatory views illustrating a liquid flow during a recovery operation in a third embodiment and a second comparative example, FIG. 10A being a schematic view illustrating the liquid flow in the second comparative example, FIG. 10B being a schematic view illustrating the liquid flow in the third embodiment.

FIG. 11 is a view illustrating an overview of a fourth embodiment.

FIG. 12 is a view illustrating an overview of a third comparative example.

FIGS. 13A and 13B are explanatory views illustrating a liquid flow during a recovery operation in a fourth embodiment and a third comparative example, FIG. 13A being a schematic view illustrating the liquid flow in the third comparative example, FIG. 13B being a schematic view illustrating the liquid flow in the fourth embodiment.

FIG. 14 is a view illustrating an overview of a fifth embodiment.

FIG. 15 is a view illustrating an overview of a fourth comparative example.

FIGS. 16A and 16B are explanatory views illustrating a liquid flow during a recovery operation in a fifth embodiment and a fourth comparative example, FIG. 16A being a schematic view illustrating the liquid flow in the fourth comparative example, FIG. 16B being a schematic view illustrating the liquid flow in the fifth embodiment.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

Note that in this specification, the term “recording” (that may also be referred to as “printing” or “print”) refers not only to forming meaningful information such as characters and graphics, but also to forming information regardless of its meaning. In addition, the term broadly encompasses forming images, designs, patterns, or the like on a recording medium, or processing a medium, regardless of whether the result is manifested in a form perceptible to the human eye.

### Liquid Ejection Head

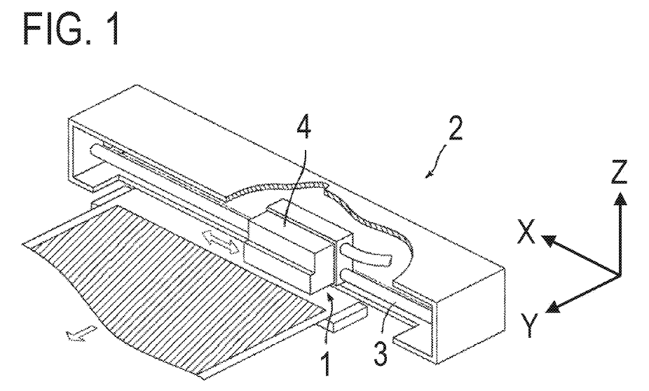

FIG. 1 is a schematic perspective view illustrating the general configuration of a liquid ejection device 2 in which a liquid ejection head 1 according to an embodiment of the present disclosure is installed. In an inkjet printer or the like serving as a recording device, the liquid ejection head 1 is configured as an inkjet recording head (head unit) used to record a desired image on a recording medium by ejecting ink as a recording liquid onto the recording medium. However, the present disclosure can also be suitably applied to applications other than inkjet recording heads.

As a recording system of the liquid ejection device 2 (recording device) according to the present embodiment, a piezoelectric system or a thermal system is suitably adopted. The piezoelectric system refers to a system in which a voltage is applied to a piezoelectric element, which serves as a recording element, to change its volume, and the energy generated at that time is used to eject ink. Furthermore, the thermal system refers to a system in which ink is heated by a heater, which serves as a recording element, to generate air bubbles, and the energy generated at that time is used to eject the ink. Note that a method other than these may also be used.

The liquid ejection device 2 of the present embodiment is a serial-scan-type recording device, in which a carriage 4 is movably guided in the main scanning direction by a guide shaft 3. The liquid ejection head 1 is mounted on the carriage 4 and is installed in the liquid ejection device 2 so as to be relatively movable with respect to a recording medium. The carriage 4 is reciprocated in the main scanning direction by a carriage motor (not illustrated) and a driving force transmission mechanism (not illustrated), such as a belt for transmitting the driving force of the motor. The liquid ejection device 2 repeats a recording operation (printing operation), in which a liquid such as ink is ejected toward a recording medium while moving the liquid ejection head 1 in the main scanning direction, and a conveying operation, in which a recording medium is conveyed in the sub-scanning direction by a distance corresponding to the recording width. In this manner, a desired image or the like is recorded on a recording medium. At this time, the liquid ejection device 2 conveys the recording medium in a direction crossing the main scanning direction of the liquid ejection head 1, using a conveying mechanism such as a feed roller (not illustrated).

In the following description, the main scanning direction of the liquid ejection device 2 is defined as the X direction, the sub-scanning direction is defined as the Y direction, and the direction crossing the X and Y directions is defined as the Z direction. Note that in a recording portion in which a recording operation is performed by the liquid ejection head 1, the conveying direction of a recording medium by the conveying mechanism is parallel to the Y direction, and the width direction of the recording medium is parallel to the X direction. Furthermore, in the present embodiment, the X, Y, and Z directions are orthogonal to each other.

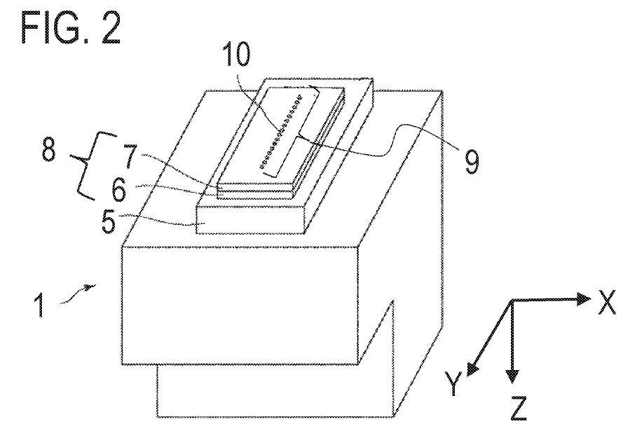

FIG. 2 is a schematic perspective view illustrating the general configuration of the liquid ejection head 1. The liquid ejection head 1 has a support member 5, a recording element substrate 6, and an ejection port forming member 7. The ejection port forming member 7 includes a plurality of ejection port rows 9 in which a plurality of ejection ports 10 for ejecting a liquid are arranged at substantially even intervals. Inside the recording element substrate 6 to which the ejection port forming member 7 is connected, a flow path through which the liquid ejected from the ejection ports 10 passes is formed. The recording element substrate 6 and the ejection port forming member 7 constitute a liquid ejection substrate (liquid ejection head substrate) 100 that ejects the liquid in the liquid ejection head 1. The liquid stored in a tank (not illustrated) is supplied to the liquid ejection head 1 and is supplied to the ejection ports 10 via a flow path provided in the support member 5.

The liquid ejection device 2 is configured to be capable of performing a specified recovery operation for the purpose of suppressing an increase in the viscosity of the liquid in the liquid ejection head 1 and discharging air bubbles generated in the liquid. The recovery operation includes, for example, suction recovery using a cap, the preliminary ejection of the recording elements, and the like. Note that the preliminary ejection is executed independently of a recording signal for performing a recording operation and refers to an ink ejection operation, which is also referred to as idle ejection and does not perform recording onto a recording medium. These maintenance operations are appropriately performed during intervals between recording operations (printing operations).

The liquid ejection device 2 according to the present embodiment is an inkjet recording device in which a liquid such as ink is circulated between the tank and the liquid ejection head. However, the liquid ejection device 2 is not limited to this configuration and may employ other configurations. For example, the liquid ejection device 2 may have two tanks provided on the upstream and downstream sides of the liquid ejection head without circulating the ink and cause the ink to flow from one tank to the other tank to fluidize the ink in individual liquid chambers (pressure chambers).

Furthermore, the liquid ejection head 1 according to the present embodiment is a so-called serial-type liquid ejection head, which performs recording while scanning a recording medium. However, the present embodiment can also be applied to so-called line-type heads having a length corresponding to the width of the recording medium. In the present embodiment, the serial-type liquid ejection head is configured to include an ejection port row for black ink and an ejection port row for color ink on one recording element substrate, but the present invention is not limited to this. For example, the serial-type liquid ejection head may be configured to have one recording element substrate for black ink and one recording element substrate for color ink. Furthermore, for example, a short line head may be configured in which several recording element substrates are arranged so that their ejection port nozzle rows overlap in the direction of the nozzle rows. This short line head is shorter than the width of a recording medium and may be configured to scan the recording medium.

### Liquid Ejection Head

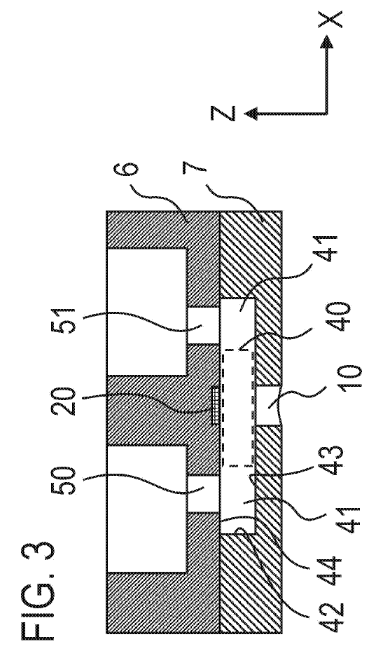

The detailed configuration of the liquid ejection head 1 will be described. FIG. 3 is a cross-sectional view near the ejection ports 10 of the liquid ejection substrate 100 as viewed in the Y direction. The flow path formed inside the liquid ejection head 1 includes a supply port 50 (liquid supply port), a common liquid chamber 41, an individual liquid chamber 40 serving as a pressure chamber, a recovery port 51 (liquid recovery port), and the like. The supply port 50 and the recovery port 51 are independent ports that open on the joining surface between the recording element substrate 6 and the ejection port forming member 7. The common liquid chamber 41 is arranged so as to cover both ends of the individual liquid chamber 40 in the X direction. The supply port 50 is in communication with one end of the common liquid chamber 41 connected to the individual liquid chamber 40, and the recovery port 51 is in communication with the other end of the common liquid chamber 41 connected to the individual liquid chamber 40.

The flow path wall of the common liquid chamber 41 includes the wall surface of the recording element substrate 6 and the wall surface of the ejection port forming member 7. More specifically, the flow path wall of the common liquid chamber 41 includes an inner wall surface 42 of the ejection port forming member 7 extending in the Z direction, an inner wall surface 43 of the ejection port forming member 7 orthogonal to the Z direction, and an end surface 44 of the recording element substrate 6. The inner wall surface 43 is the surface on which the ejection ports 10 open. Furthermore, the inner wall surface 43 and the end surface 44 also form a part of the flow path wall of the individual liquid chamber 40.

The liquid ejection head 1 includes a recording element 20, which serves as an energy generation element that generates energy for performing a recording operation. The recording element 20 may also be referred to as a driving element because it is driven to perform a recording operation. The recording element 20 is, when viewed in the Z direction, arranged on the end surface 44 of the recording element substrate 6 at a position overlapping the ejection ports 10 on the recording element substrate 6.

In the recording operation, inside the liquid ejection head 1, the liquid flows from the supply port 50 to the individual liquid chamber 40 via the common liquid chamber 41 on the supply side. Then, the liquid is ejected from the individual liquid chamber 40 via the ejection ports 10 as the recording element 20 is driven. On the other hand, the liquid not ejected from the individual liquid chamber 40 flows to the recovery port 51 via the common liquid chamber 41 on the recovery side. This flow path configuration enables circulation of the liquid.

Next, the detailed configuration of the liquid ejection head 1 will be described by dividing it into a plurality of embodiments. Among the plurality of embodiments, the arrangement in the XY plane of the ejection ports 10, the individual liquid chamber 40, the supply port 50, the recovery port 51, and the like that constitute a liquid flow path is different. Furthermore, in the following description, configurations on one-end side in the longitudinal direction of the liquid ejection substrate 8 will be mainly described, but the other-end side opposite to the one-end side may have the same configurations as those on the one-end side.

### First Embodiment

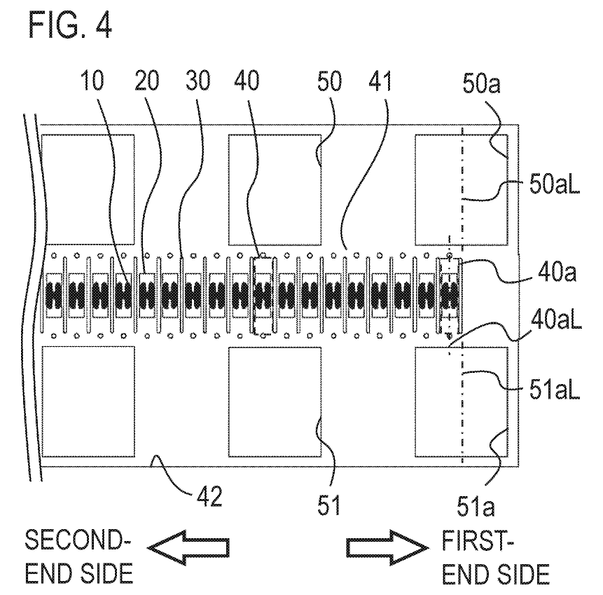

FIG. 4 illustrates an overview of a first embodiment according to the present disclosure. FIG. 4 is a view illustrating the principal configurations near the end of the ejection port row 9 of the liquid ejection head 1 in the first embodiment and illustrates the arrangement relationship between the principal configurations when the liquid ejection substrate 8 is viewed in the Z direction.

On the liquid ejection substrate 8 of the liquid ejection head 1, the recording elements 20 for recording, the ejection ports 10 that correspond to the recording elements 20, flow path walls 30 that surround the recording elements, and the individual liquid chambers 40 that serve as pressure chambers surrounded by the flow path walls 30 are each arranged at uniform intervals along a specified arrangement direction. In other words, in the arrangement direction, the distance between adjacent recording elements 20, the distance between adjacent discharge ports 10, the distance between adjacent flow path walls 30, and the distance between adjacent individual liquid chambers 40 are constant. The individual liquid chambers 40 are provided corresponding to the plurality of ejection ports 10, respectively, and the recording elements 20 are provided corresponding to the plurality of individual liquid chambers 40, respectively.

The specified arrangement direction is, for example, the longitudinal direction of the recording element substrate 6 and a direction (a sub-scanning direction or Y direction) that is parallel to the conveying direction of a recording medium. Along this arrangement direction, a plurality of supply ports 50 and a plurality of recovery ports 51 are arranged on both sides of the recording elements 20 and the ejection ports 10 in a direction (a main scanning direction or X direction) orthogonal to the arrangement direction. Relative to the row of the recording elements 20 and the ejection ports 10, the plurality of supply ports 50 are arranged on one side in the direction orthogonal to the arrangement direction, while the plurality of recovery ports 51 are arranged on the other side in the direction orthogonal to the arrangement direction. The supply ports 50 and the recovery ports 51 are each arranged at uniform intervals along the specified arrangement direction. In other words, in the arrangement direction, the distance between adjacent supply ports 50, and the distance between adjacent recovery ports 51 are constant.

In the first embodiment, the plurality of individual liquid chambers 40 are arranged at intervals of 1200 dpi along the arrangement direction. Furthermore, the plurality of supply ports 50 and the plurality of recovery ports 51 are each arranged at intervals of 150 dpi along the arrangement direction.

The common liquid chamber 41 of the first embodiment includes a portion that extends in the Y direction and is in communication with the plurality of supply ports 50, a portion that extends in the Y direction and is in communication with the plurality of recovery ports 51, and a portion that connects the ends of these two portions in the Y direction. In the common liquid chamber 41, the portion in communication with the plurality of supply ports 50 is in communication with one end of each of the plurality of individual liquid chambers 40, and the portion in communication with the plurality of recovery ports 51 is in communication with the other end of each of the plurality of individual liquid chambers 40. With this configuration, the liquid is supplied from the supply ports 50 to the individual liquid chambers 40 via the common liquid chamber 41 and is recovered from the individual liquid chambers 40 into the recovery ports 51 via the common liquid chamber 41.

As described above, in the first embodiment, the plurality of ejection ports 10, the plurality of individual liquid chambers 40, the plurality of supply ports 50, and the plurality of recovery ports 51 are each arranged side by side in the arrangement direction from one end to the other end of the liquid ejection head 1. In the following description, one end in the arrangement direction of the liquid ejection head 1 is defined as a first end, and the other end opposite to the one end is defined a second end. Furthermore, in the following description, the individual liquid chamber 40 that is arranged at one end in the arrangement direction among the plurality of individual liquid chambers 40 and is located closest to the first end of the liquid ejection head 1 will be referred to as a first individual liquid chamber 40a. Similarly, the supply port 50 that is arranged at one end in the arrangement direction among the plurality of supply ports 50 and is located closest to the first end of the liquid ejection head 1 will be referred to as a first supply port 50a. Similarly, the recovery port 51 that is arranged at one end in the arrangement direction among the plurality of recovery ports 51 and is located closest to the first end of the liquid ejection head 1 will be referred to as a first recovery port 51a.

In the first embodiment, the first supply port 50a and the first recovery port 51a are located closer to the first end (on the outer side) than the first individual liquid chamber 40a. Furthermore, a center line 50aL in the arrangement direction of the first supply port 50a and a center line 51aL in the arrangement direction of the first recovery port 51a are located closer to the first end (on the outer side) than a center line 40aL in the arrangement direction of the first individual liquid chamber 40a.

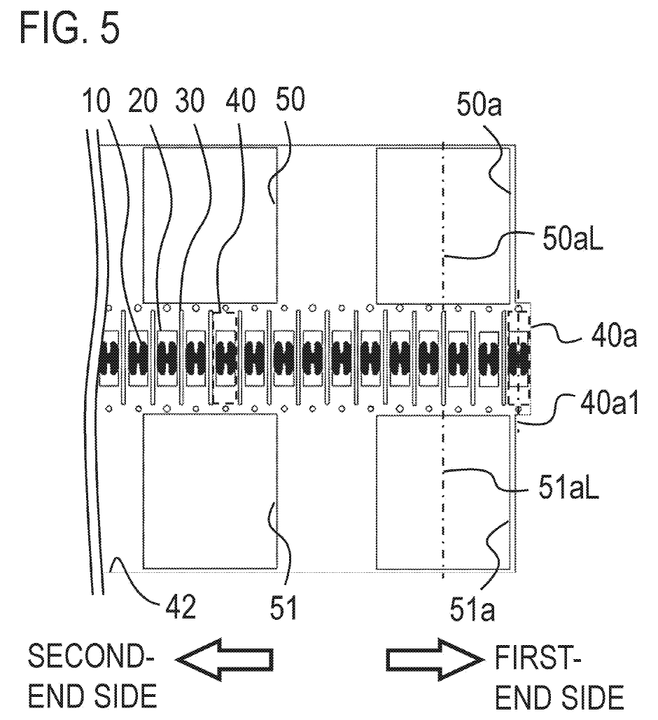

FIG. 5 illustrates an overview of a first comparative example. FIG. 5 is a view illustrating the principal configurations near the end of the ejection port row 9 of the liquid ejection head 1 according to the first comparative example and illustrates the arrangement relationship between the principal configurations when the liquid ejection substrate 8 is viewed in the Z direction. In the first comparative example, the positional relationship between the first individual liquid chamber 40a and the first supply port 50a and the first recovery port 51a is different from that in the first embodiment.

In the first comparative example, the first individual liquid chamber 40a is located closer to the first end (on the outer side) than the first supply port 50a and the first recovery port 51a. In the first comparative example, the common liquid chamber 41 includes a portion in communication with the supply ports 50 and a portion in communication with the recovery ports 51, which are separated with the plurality of individual liquid chambers 40 interposed therebetween. Furthermore, the end surface on the first-end side of the first individual liquid chamber 40a protrudes toward the first-end side at least from a part of the end surface on the first-end side of the common liquid chamber 41.

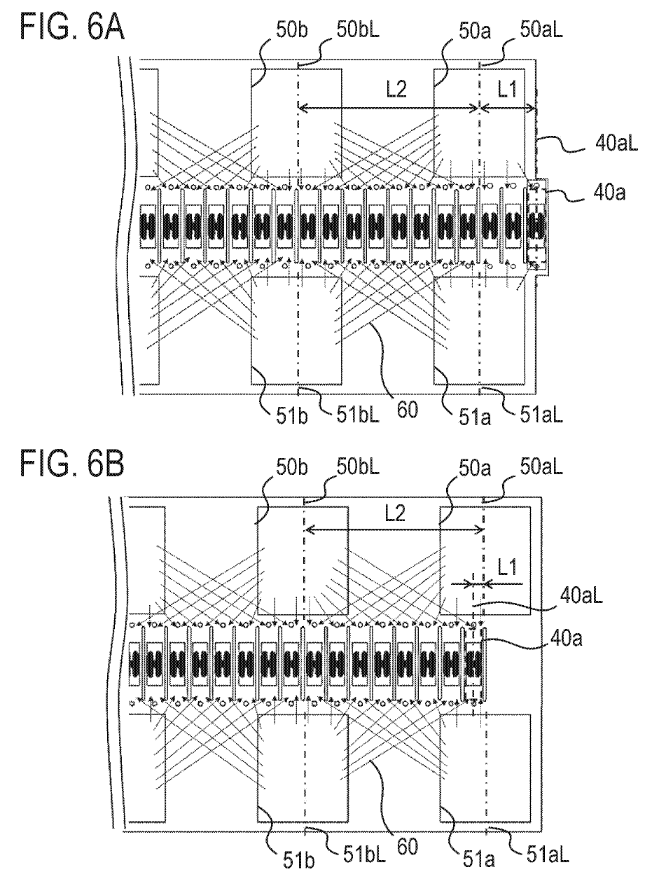

The liquid flow during the recovery operation of the liquid ejection head 1 in the configurations of the first embodiment and the first comparative example will be described. FIGS. 6A and 6B are explanatory views illustrating the liquid flow during the recovery operation of the liquid ejection head 1 in the first embodiment and the first comparative example, where a liquid flow 60 is indicated by a plurality of arrows. FIG. 6A is a schematic view illustrating the liquid flow 60 in the first comparative example and is a cross-sectional view corresponding to FIG. 5. FIG. 6B is a schematic view illustrating the liquid flow 60 in the first embodiment and is a cross-sectional view corresponding to FIG. 4.

When a recovery operation such as suction recovery using a cap or the preliminary ejection of the recording elements is performed, the liquid flows from the supply ports 50 and the recovery ports 51 into the common liquid chamber 41 and further flows from the common liquid chamber 41 into the plurality of individual liquid chambers 40. Then, the liquid that has flowed into the individual liquid chambers 40 is discharged to the outside of the liquid ejection head 1 via the ejection ports 10.

In the first comparative example, as shown in FIG. 6A, the liquid flows into the individual liquid chambers 40 arranged at positions other than the end in the arrangement direction such among the plurality of individual liquid chambers 40 that the liquid is supplied from two supply ports 50 and two recovery ports 51. On the other hand, the liquid is supplied only from the first supply port 50a and the first recovery port 51a to the individual liquid chamber 40 arranged at the end, such as the first individual liquid chamber 40a. That is, in the first comparative example, the amount of the liquid supplied to the individual liquid chamber 40 at the end of the ejection port row 9 is smaller than that supplied to the individual liquid chambers 40 in the central portion. This is because the distance between the individual liquid chamber 40 arranged at the end and a supply port 50 other than the first supply port 50a and a recovery port 51 other than the first recovery port 51a is large.

During the recovery operation, if the amount of the liquid supplied is small and insufficient, the recovery performance (the recovery effect of the recovery operation) decreases. Furthermore, thickened ink or air bubbles are particularly likely to occur at the end of the ejection port row 9 and are easily discharged from the ejection ports 10 at the end. If the amount of the liquid supplied to the individual liquid chamber 40 at the end is insufficient, the recovery effect of the recovery operation may be inadequate, causing clogging of the ejection ports 10 at the end and potentially leading to printing failures in the liquid ejection head 1.

On the other hand, in the first embodiment, the first individual liquid chamber 40a is located farther from the first end (on the inner side) than in the first comparative example. Accordingly, the distance from the first individual liquid chamber 40a to a second supply port 50b adjacent to the first supply port 50a and the distance from the first individual liquid chamber 40a to a second recovery port 51b adjacent to the first recovery port 51a are smaller in the first embodiment than in the first comparative example. With this configuration, the liquid is supplied from a plurality of supply ports 50 and a plurality of recovery ports 51 even to the individual liquid chamber 40 at the end including the first individual liquid chamber 40a, thereby increasing the amount of the liquid supplied to the individual liquid chamber 40 at the end and improving the recovery performance as compared with the first comparative example. Consequently, it is possible to prevent degradation in the printing quality of the liquid ejection head 1.

In the first embodiment, the center line 40aL of the first individual liquid chamber 40a is located farther from the first end (on the inner side) than the center line 50aL of the first supply port 50a and the center line 51aL of the first recovery port 51a in the arrangement direction. Furthermore, a distance L1 from the center line 40aL to the center line 50aL is set to not more than 1/2 (half) of a distance L2 from the center line 50aL to a center line 50bL of a second supply port 50b. Furthermore, the distance from the center line 40aL to the center line 51aL is equal to the distance L1, and the distance from the center line 51aL to a center line 51bL of a second recovery port 51b is equal to the distance L2. With this configuration, the liquid is supplied from at least two supply ports 50 and at least two recovery ports 51 to all the individual liquid chambers 40 including the first individual liquid chamber 40a, thereby enabling a sufficient amount of the liquid to be supplied to all the individual liquid chambers 40. Note that although the first comparative example is also configured such that L1 < 1/2 × L2, the center line 40aL is located closer to the first end (outer side) than the center line 50aL and the center line 51aL. Therefore, the amount of the liquid supplied may be insufficient.

In the first embodiment, the individual liquid chambers 40 are arranged at 1200 dpi, while the supply ports 50 and the recovery ports 51 are arranged at 150 dpi. In other words, in the arrangement direction, the ratio of the distance between adjacent individual liquid chambers 40 to the distance between adjacent supply ports 50 (recovery ports 51) is 1:8. If the arrangement interval between the supply ports 50 and between the recovery ports 51 becomes larger, the liquid supply performance to the individual liquid chambers 40 may deteriorate. Accordingly, when the distance between adjacent individual liquid chambers 40 is represented by X1 and the distance between adjacent supply ports 50 (recovery ports 51) is represented by X2, it is preferable that X2/X1 be not more than 8.

Note that although the configurations at the end on the first-end side of the liquid ejection head 1 have been described above, it is preferable that the configurations at the end on the second-end side be the same. In this case, the supply port 50 and the recovery port 51 at the end on the second-end side are located closer to the second end (on the outer side) than the individual liquid chamber 40 at the end on the second-end side. Furthermore, the center line in the arrangement direction of the supply port 50 and the center line in the arrangement direction of the recovery port are each located closer to the second end (on the outer side) than the center line in the arrangement direction of the individual liquid chamber.

### Second Embodiment

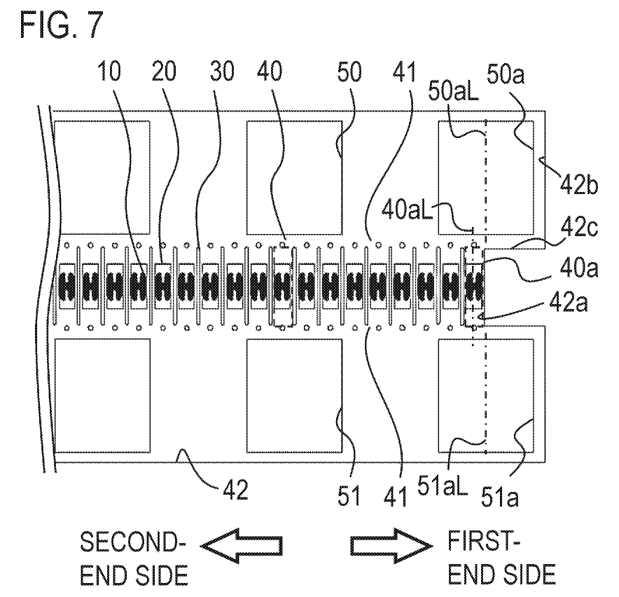

FIG. 7 illustrates an overview of a second embodiment according to the present disclosure. FIG. 7 is a view illustrating the principal configurations near the end of the ejection port row 9 of the liquid ejection head 1 in the second embodiment and illustrates the arrangement relationship between the principal configurations when the liquid ejection substrate 8 is viewed in the Z direction. In the second embodiment, configurations that are the same as those in the first embodiment will be assigned the same reference numerals, and their description will be omitted.

In the second embodiment, the common liquid chamber 41 includes a portion in communication with the supply ports 50 and a portion in communication with the recovery ports 51, which are separated with the plurality of individual liquid chambers 40 interposed therebetween. The inner wall surface 42 of the ejection port forming member 7, which extends in Z direction, constitutes the wall surface of the first individual liquid chamber 40a in addition to the common liquid chamber 41. The inner wall surface 42 includes a first surface 42a, a second surface 42b, and a third surface 42c. The first surface 42a is the end surface on the first-end side of the first individual liquid chamber 40a. The second surface 42b is the end surface on the first-end side of the common liquid chamber 41, which is formed on the first-end side relative to the first surface 42a. The third surface 42c is a connecting surface that extends in the arrangement direction and connects the first surface 42a to the second surface 42b. As described above, the inner wall surface 42 in the second embodiment is formed such that the first surface 42a is located farther from the first end (toward the second-end side) relative to the second surface 42b. Furthermore, the inner wall surface 42 on the side of the recovery ports 51 is configured in the same manner as that on the side of the supply ports 50. That is, the inner wall surface 42 on the first-end side of the ejection port forming member 7 is formed in a convex shape with its central portion in the X direction protruding toward the second-end side.

In the first embodiment, the common liquid chamber 41 is formed adjacent to the first-end side of the first individual liquid chamber 40a. Accordingly, during a recovery operation, some of the liquid supplied from the first supply port 50a and the first recovery port 51a may flow into the common liquid chamber 41 without flowing into the individual liquid chamber 40. On the other hand, in the second embodiment, because the inner wall surface 42 is formed in a convex shape, no common liquid chamber 41 is formed adjacent to the first individual liquid chamber 40a, thereby easily ensuring the amount of the liquid flowing into the first individual liquid chamber 40a. Accordingly, from the viewpoint of reducing the amount of the liquid flowing into unnecessary portions and ensuring the amount of the liquid flowing into the individual liquid chamber 40, it is preferable to configure the inner wall surface 42 so as to prevent unnecessary flow paths as in the second embodiment.

### Third Embodiment

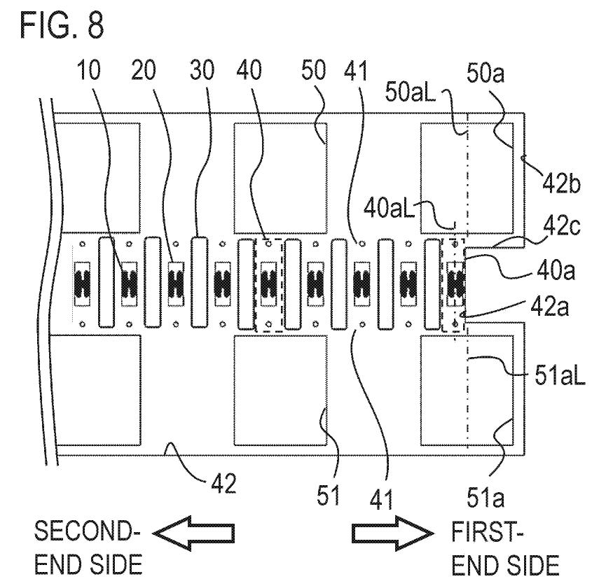

FIG. 8 illustrates an overview of a third embodiment according to the present disclosure. FIG. 8 is a view illustrating the principal configurations near the end of the ejection port row 9 of the liquid ejection head 1 in the third embodiment and illustrates the arrangement relationship between the principal configurations when the liquid ejection substrate 8 is viewed in the Z direction. Hereinafter, in the third embodiment, configurations that are the same as those in the above-described embodiments will be assigned the same reference numerals, and their description will be omitted.

In the third embodiment, the arrangement interval between the individual liquid chambers 40 is different from that in the first embodiment. In the third embodiment, the individual liquid chambers 40 are arranged at intervals of 600 dpi in the arrangement direction, while the supply ports 50 and the recovery ports 51 are each arranged at intervals of 150 dpi in the arrangement direction.

In the third embodiment as well, the first supply port 50a and the first recovery port 51a are located closer to the first end (on the outer side) than the first individual liquid chamber 40a. Furthermore, the center line 50aL in the arrangement direction of the first supply port 50a and the center line 51aL in the arrangement direction of the first recovery port 51a are each located closer to the first end (on the outer side) than the center line 40aL in the arrangement direction of the first individual liquid chamber 40a. Furthermore, the end on the first-end side of the inner wall surface 42 includes the first surface 42a, the second surface 42b, and the third surface 42c, and a central portion in the X direction is formed in a convex shape so as to protrude toward the second-end side.

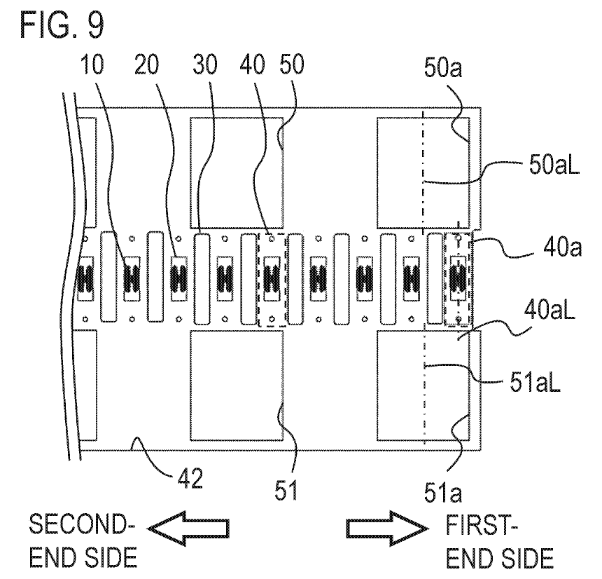

FIG. 9 illustrates an overview of a second comparative example. FIG. 9 is a view illustrating the principal configurations near the end of the ejection port row 9 of the liquid ejection head 1 according to the second comparative example and illustrates the arrangement relationship between the principal configurations when the liquid ejection substrate 8 is viewed in the Z direction. In the second comparative example, the positional relationship between the first individual liquid chamber 40a and the first supply port 50a and the first recovery port 51a is different from that in the third embodiment. Specifically, in the second comparative example, the first individual liquid chamber 40a is located closer to the first end (on the outer side) than the first supply port 50a and the first recovery port 51a.

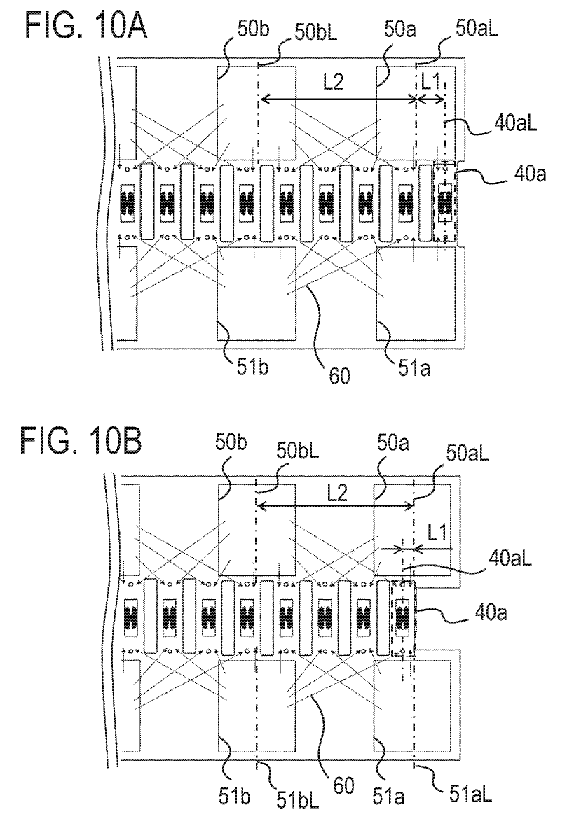

The liquid flow during the recovery operation of the liquid ejection head 1 in the configurations of the third embodiment and the second comparative example will be described. FIGS. 10A and 10B are explanatory views illustrating the liquid flow during the recovery operation of the liquid ejection head 1 in the third embodiment and the second comparative example, where the liquid flow 60 is indicated by a plurality of arrows. FIG. 10A is a schematic view illustrating the liquid flow 60 in the second comparative example and is a cross-sectional view corresponding to FIG. 9. FIG. 10B is a schematic view illustrating the liquid flow 60 in the third embodiment and is a cross-sectional view corresponding to FIG. 8.

In the second comparative example, similarly to the first comparative example, the liquid is supplied only from the first supply port 50a and the first recovery port 51a to the individual liquid chamber 40 arranged at the end, such as the first individual liquid chamber 40a. On the other hand, in the third embodiment, the first individual liquid chamber 40a is located farther from the first end (on the inner side) than in the second comparative example. Accordingly, the distance from the first individual liquid chamber 40a to the second supply port 50b adjacent to the first supply port 50a and the distance from the first individual liquid chamber 40a to the second recovery port 51b adjacent to the first recovery port 51a are smaller in the third embodiment than in the second comparative example. With this configuration, the liquid is supplied from a plurality of supply ports 50 and a plurality of recovery ports 51 even to the individual liquid chamber 40 at the end including the first individual liquid chamber 40a, thereby increasing the amount of the liquid supplied to the individual liquid chamber 40 at the end and improving the recovery performance as compared with the second comparative example. Consequently, it is possible to prevent degradation in the printing quality of the liquid ejection head 1.

Furthermore, in the third embodiment as well, the center line 40aL of the first individual liquid chamber 40a is located farther from the first end (on the inner side) than the center line 50aL of the first supply port 50a and the center line 51aL of the first recovery port 51a in the arrangement direction. Furthermore, the distance L1 from the center line 40aL to the center line 50aL is set to not more than 1/2 (half) of the distance L2 from the center line 50aL to the center line 50bL of the second supply port 50b. Note that although the second comparative example is also configured such that L1 < 1/2 × L2, the center line 40aL is located closer to the first end (on the outer side) than the center line 50aL and the center line 51aL, the amount of the liquid supplied may be insufficient.

In the third embodiment, the individual liquid chambers 40 are arranged at 600 dpi, while the supply ports 50 and the recovery ports 51 are arranged at 150 dpi. In other words, in the arrangement direction, the ratio of the distance between adjacent individual liquid chambers 40 to the distance between adjacent supply ports 50 (recovery ports 51) is 1:4. Furthermore, when the distance between adjacent individual liquid chambers 40 is represented by X1 and the distance between adjacent supply ports 50 (recovery ports 51) is represented by X2, X2/X1 equals 4.

With this configuration, according to the third embodiment, the liquid is supplied from a plurality of supply ports 50 and a plurality of recovery ports 51 to all the individual liquid chambers 40 including the first individual liquid chamber 40a, thereby enabling a sufficient amount of the liquid to be supplied to all the individual liquid chambers 40. In addition, because the inner wall surface 42 on the first-end side is formed in a convex shape, the amount of the liquid flowing into areas other than the individual liquid chambers 40 can be reduced. Consequently, the recovery performance during the recovery operation is improved, making it possible to prevent degradation in the printing quality of the liquid ejection head 1.

### Fourth Embodiment

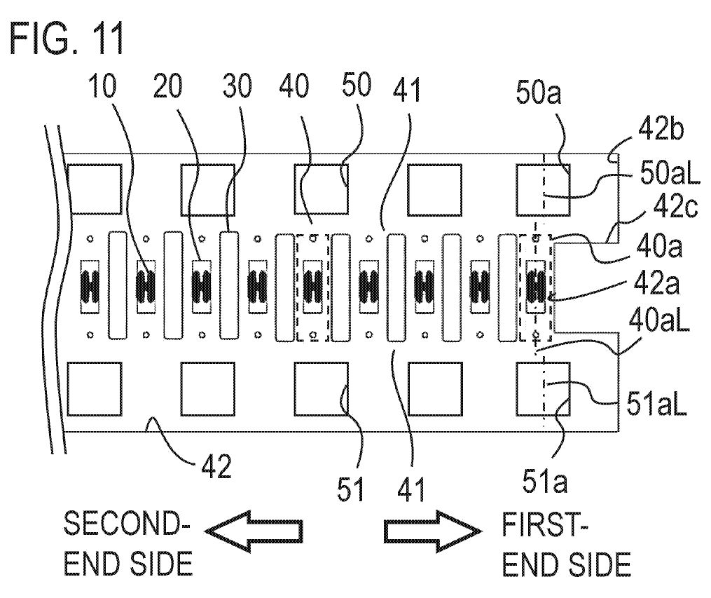

FIG. 11 illustrates an overview of a fourth embodiment according to the present disclosure. FIG. 11 is a view illustrating the principal configurations near the end of the ejection port row 9 of the liquid ejection head 1 in the fourth embodiment and illustrates the arrangement relationship between the principal configurations when the liquid ejection substrate 8 is viewed in the Z direction. Hereinafter, in the fourth embodiment, configurations that are the same as those in the above-described embodiments will be assigned the same reference numerals, and their description will be omitted.

In the fourth embodiment, the arrangement interval between the individual liquid chambers 40, between the supply ports 50, and between the recovery ports 51 is different from that in the first embodiment. In the fourth embodiment, the individual liquid chambers 40 are arranged at intervals of 600 dpi in the arrangement direction, while the supply ports 50 and the recovery ports 51 are each arranged at intervals of 300 dpi in the arrangement direction.

In the fourth embodiment as well, the first supply port 50a and the first recovery port 51a are located closer to the first end (on the outer side) than the first individual liquid chamber 40a. Furthermore, the center line 50aL in the arrangement direction of the first supply port 50a and the center line 51aL in the arrangement direction of the first recovery port 51a are each located closer to the first end (on the outer side) than the center line 40aL in the arrangement direction of the first individual liquid chamber 40a. Furthermore, the end on the first-end side of the inner wall surface 42 includes the first surface 42a, the second surface 42b, and the third surface 42c, and the central portion in the X direction is formed in a convex shape so as to protrude toward the second-end side.

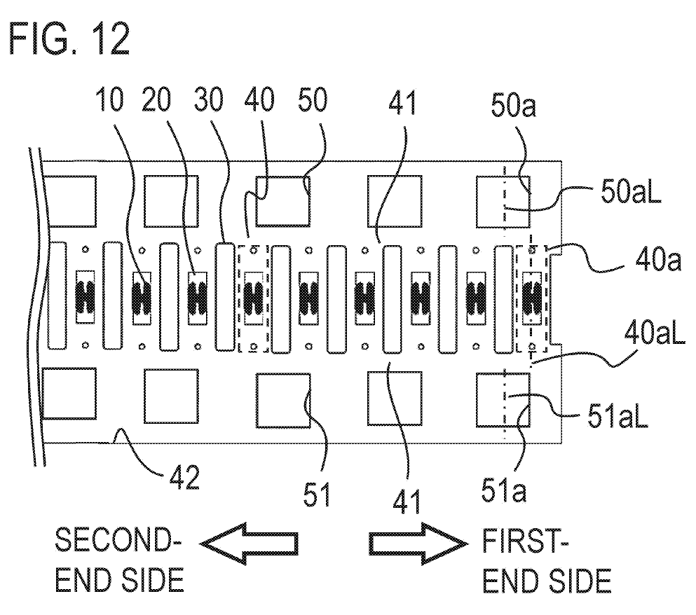

FIG. 12 illustrates an overview of a third comparative example. FIG. 12 is a view illustrating the principal configurations near the end of the ejection port row 9 of the liquid ejection head 1 according to the third comparative example and illustrates the arrangement relationship between the principal configurations when the liquid ejection substrate 8 is viewed in the Z direction. In the third comparative example, the positional relationship between the first individual liquid chamber 40a and the first supply port 50a and the first recovery port 51a is different from that in the fourth embodiment. Specifically, in the third comparative example, the first individual liquid chamber 40a is located closer to the first end (on the outer side) than the first supply port 50a and the first recovery port 51a.

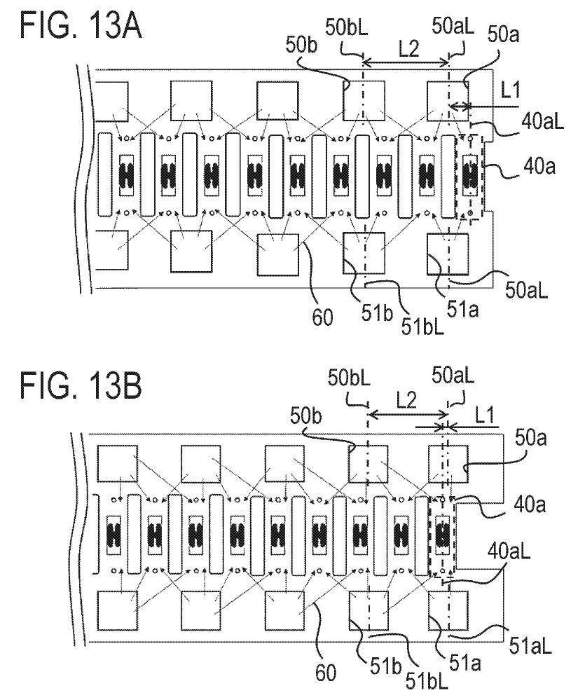

The liquid flow during the recovery operation of the liquid ejection head 1 in the configurations of the fourth embodiment and the third comparative example will be described. FIGS. 13A and 13B are explanatory views illustrating the liquid flow during the recovery operation of the liquid ejection head 1 in the fourth embodiment and the third comparative example, where the liquid flow 60 is indicated by a plurality of arrows. FIG. 13A is a schematic view illustrating the liquid flow 60 in the third comparative example and is a cross-sectional view corresponding to FIG. 12. FIG. 13B is a schematic view illustrating the liquid flow 60 in the fourth embodiment and is a cross-sectional view corresponding to FIG. 11.

In the third comparative example, similarly to the first comparative example, the liquid is supplied only from the first supply port 50a and the first recovery port 51a to the individual liquid chamber 40 arranged at the end, such as the first individual liquid chamber 40a. On the other hand, in the fourth embodiment, the first individual liquid chamber 40a is located farther from the first end (on the inner side) than in the third comparative example. Accordingly, the distance from the first individual liquid chamber 40a to the second supply port 50b adjacent to the first supply port 50a and the distance from the first individual liquid chamber 40a to the second recovery port 51b adjacent to the first recovery port 51a are smaller in the fourth embodiment than in the third comparative example. With this configuration, the liquid is supplied from a plurality of supply ports 50 and a plurality of recovery ports 51 even to the individual liquid chamber 40 at the end including the first individual liquid chamber 40a, thereby increasing the amount of the liquid supplied to the individual liquid chamber 40 at the end and improving the recovery performance as compared with the third comparative example. Consequently, it is possible to prevent degradation in the printing quality of the liquid ejection head 1.

Furthermore, in the fourth embodiment as well, the center line 40aL of the first individual liquid chamber 40a is located farther from the first end (on the inner side) than the center line 50aL of the first supply port 50a and the center line 51aL of the first recovery port 51a in the arrangement direction. Furthermore, the distance L1 from the center line 40aL to the center line 50aL is set to not more than 1/2 (half) of the distance L2 from the center line 50aL to the center line 50bL of the second supply port 50b. Note that although the third comparative example is also configured such that L1 < 1/2 × L2, the center line 40aL is located closer to the first end (on the outer side) than the center line 50aL and the center line 51aL. Therefore, the amount of the liquid supplied may be insufficient.

In the fourth embodiment, the individual liquid chambers 40 are arranged at 600 dpi, while the supply ports 50 and the recovery ports 51 are arranged at 300 dpi. In other words, in the arrangement direction, the ratio of the distance between adjacent individual liquid chambers 40 to the distance between adjacent supply ports 50 (recovery ports 51) is 1:2. Furthermore, when the distance between adjacent individual liquid chambers 40 is represented by X1 and the distance between adjacent supply ports 50 (recovery ports 51) is represented by X2, X2/X1 equals 2.

With this configuration, according to the fourth embodiment, the liquid is supplied from a plurality of supply ports 50 and a plurality of recovery ports 51 to all the individual liquid chambers 40 including the first individual liquid chamber 40a, thereby enabling a sufficient amount of the liquid to be supplied to all the individual liquid chambers 40. In addition, because the inner wall surface 42 on the first-end side is formed in a convex shape, the amount of the liquid flowing into areas other than the individual liquid chambers 40 can be reduced. Consequently, the recovery performance during the recovery operation is improved, making it possible to prevent degradation in the printing quality of the liquid ejection head 1.

### Fifth Embodiment

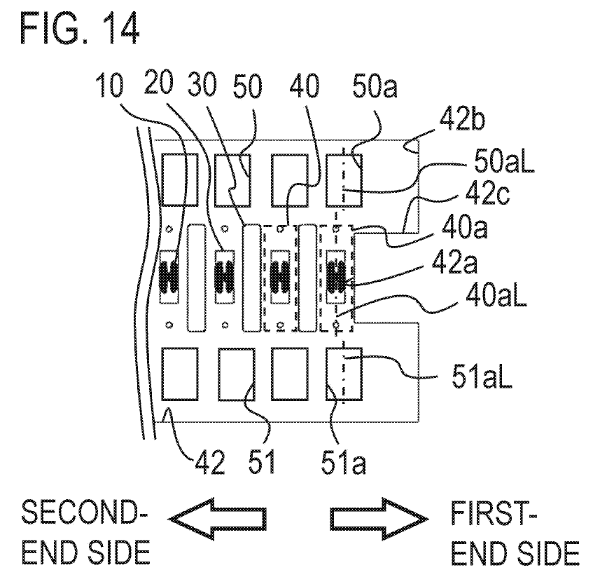

FIG. 14 illustrates an overview of a fifth embodiment according to the present disclosure. FIG. 14 is a view illustrating the principal configurations near the end of the ejection port row 9 of the liquid ejection head 1 in the fifth embodiment and illustrates the arrangement relationship between the principal configurations when the liquid ejection substrate 8 is viewed in the Z direction. Hereinafter, in the fifth embodiment, configurations that are the same as those in the above-described embodiments will be assigned the same reference numerals, and their description will be omitted.

In the fifth embodiment, the arrangement interval between the individual liquid chambers 40, between the supply ports 50, and between the recovery ports 51 is different from that in the first embodiment. In the fifth embodiment, the individual liquid chambers 40 are arranged at intervals of 600 dpi in the arrangement direction, while the supply ports 50 and the recovery ports 51 are each arranged at intervals of 600 dpi in the arrangement direction.

In the fifth embodiment as well, the first supply port 50a and the first recovery port 51a are located closer to the first end (on the outer side) than the first individual liquid chamber 40a. Furthermore, the center line 50aL in the arrangement direction of the first supply port 50a and the center line 51aL in the arrangement direction of the first recovery port 51a are each located closer to the first end (on the outer side) than the center line 40aL in the arrangement direction of the first individual liquid chamber 40a. Furthermore, the end on the first-end side of the inner wall surface 42 includes the first surface 42a, the second surface 42b, and the third surface 42c, and the central portion in the X direction is formed in a convex shape so as to protrude toward the second-end side.

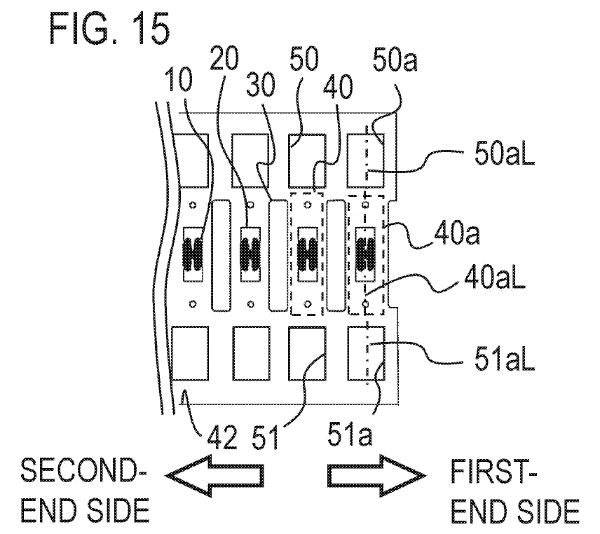

FIG. 15 illustrates an overview of a fourth comparative example. FIG. 15 is a view illustrating the principal configurations near the end of the ejection port row 9 of the liquid ejection head 1 according to the fourth comparative example and illustrates the arrangement relationship between the principal configurations when the liquid ejection substrate 8 is viewed in the Z direction. In the fourth comparative example, the positional relationship between the first individual liquid chamber 40a and the first supply port 50a and the first recovery port 51a is different from that in the fifth embodiment. Specifically, in the fourth comparative example, the first individual liquid chamber 40a, the first supply port 50a, and the first recovery port 51a are located at substantially the same position in the arrangement direction.

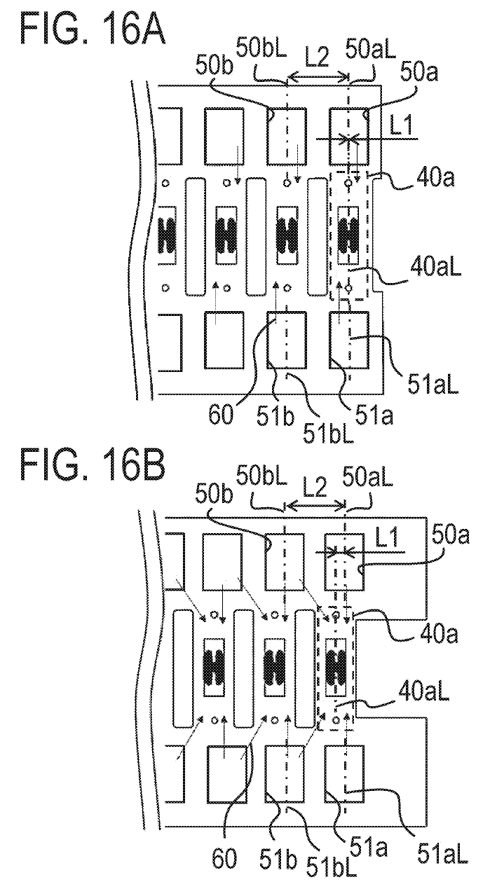

The liquid flow during the recovery operation of the liquid ejection head 1 in the configurations of the fifth embodiment and the fourth comparative example will be described. FIGS. 16A and 16B are explanatory views illustrating the liquid flow during the recovery operation of the liquid ejection head 1 in the fifth embodiment and the fourth comparative example, where the liquid flow 60 is indicated by a plurality of arrows. FIG. 16A is a schematic view illustrating the liquid flow 60 in the fourth comparative example and is a cross-sectional view corresponding to FIG. 15. FIG. 16B is a schematic view illustrating the liquid flow 60 in the fifth embodiment and is a cross-sectional view corresponding to FIG. 14.

In the fourth comparative example, the liquid is supplied only from a corresponding one of the first supply ports 50a and a corresponding one of the first recovery ports 51a to each of the individual liquid chambers 40 including the first individual liquid chamber 40a. On the other hand, in the fifth embodiment, the first individual liquid chamber 40a is located farther from the first end (on the inner side) than in the fourth comparative example. Accordingly, the distance from the first individual liquid chamber 40a to the second supply port 50b adjacent to the first supply port 50a and the distance from the first individual liquid chamber 40a to the second recovery port 51b adjacent to the first recovery port 51a are smaller in the fifth embodiment than in the fourth comparative example. With this configuration, the liquid is supplied from a plurality of supply ports 50 and a plurality of recovery ports 51 even to the individual liquid chambers 40 at the end including the first individual liquid chamber 40a, thereby increasing the amount of the liquid supplied to the individual liquid chamber 40 at the end and improving the recovery performance as compared with the fourth comparative example. Consequently, it is possible to prevent degradation in the printing quality of the liquid ejection head 1.

Furthermore, in the fifth embodiment as well, the center line 40aL of the first individual liquid chamber 40a is located farther from the first end (on the inner side) than the center line 50aL of the first supply port 50a and the center line 51aL of the first recovery port 51a in the arrangement direction. Furthermore, the distance L1 from the center line 40aL to the center line 50aL is set to not more than 1/2 (half) of the distance L2 from the center line 50aL to the center line 50bL of the second supply port 50b. Note that although the fourth comparative example is also configured such that L1 < 1/2 × L2, the center line 40aL is located at substantially the same position as the center line 50aL and the center line 51aL in the arrangement direction. Therefore, the amount of the liquid supplied may be insufficient.

Furthermore, in the fourth comparative example, as illustrated in FIG. 16A, one supply port 50 and one recovery port 51 are provided corresponding to one individual liquid chamber 40 at substantially the same position in the arrangement direction. However, in such a configuration, if dust or air bubbles accumulate in the supply ports 50 or the recovery ports 51, the circulation of the liquid via the corresponding individual liquid chambers 40 may be hindered. On the other hand, in the fifth embodiment, as illustrated in FIG. 16B, the liquid is supplied to one individual liquid chamber 40 from two supply ports 50 and two recovery ports 51. Therefore, even if one of the two supply ports 50 or one of the recovery ports 51 experiences poor circulation, the liquid is reliably supplied to the individual liquid chambers 40. Furthermore, in the fifth embodiment, the numbers of the supply ports 50 and the recovery ports 51 are each one greater than the number of the individual liquid chambers 40, and two supply ports 50 and two recovery ports 51 are arranged corresponding to the individual liquid chamber 40 at the endmost portion on the second-end side opposite to the first-end side.

In the fifth embodiment, the individual liquid chambers 40 are arranged at 600 dpi, while the supply ports 50 and the recovery ports 51 are arranged at 600 dpi. In other words, in the arrangement direction, the ratio of the distance between adjacent individual liquid chambers 40 to the distance between adjacent supply ports 50 (recovery ports 51) is 1:1. Even if the arrangement interval between the supply ports 50 and between the recovery ports 51 is set smaller, the numbers of the supply ports 50 and the recovery ports 51 become excessive relative to the individual liquid chambers 40, thereby making it difficult to increase the amount of the liquid supplied. Furthermore, when the numbers of the supply ports 50 and the recovery ports 51 are large, it becomes difficult to cover the wirings for supplying power to each recording element 20. Therefore, it is necessary to increase the size of the recording element substrate 6, potentially leading to an increase in cost. Accordingly, when the distance between adjacent individual liquid chambers 40 is represented by X1 and the distance between adjacent supply ports 50 (recovery ports 51) is represented by X2, it is preferable that X2/X1 be at least 1. Furthermore, as described in the first embodiment, it is preferable that X2/X1 be not more than 8. That is, in the arrangement direction, the ratio of the distance between adjacent individual liquid chambers 40 to the distance between adjacent supply ports 50 (recovery ports 51) is preferably set within the range of 1:1 to 1:8.

As described above, according to the fifth embodiment, the liquid can be supplied from a plurality of supply ports 50 and a plurality of recovery ports 51 to all the individual liquid chambers 40 including the first individual liquid chamber 40a, thereby enabling a sufficient amount of the liquid to be supplied to all the individual liquid chambers 40. In addition, because the inner wall surface 42 on the first-end side is formed in a convex shape, the amount of the liquid flowing into areas other than the individual liquid chambers 40 can be reduced. Consequently, the recovery performance during the recovery operation is improved, making it possible to prevent degradation in the printing quality of the liquid ejection head 1.

According to the present disclosure, a liquid ejection head capable of preventing a reduction in printing quality can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-009010, filed January 22, 2025, which is hereby incorporated by reference herein in its entirety.

What is claimed is:

1. A liquid ejection head for ejecting a liquid toward a recording medium, the liquid ejection head comprising:
a plurality of ejection ports that eject the liquid, the plurality of ejection ports being arranged side by side in a specified arrangement direction;
a plurality of individual liquid chambers provided corresponding to the plurality of ejection ports, respectively, the plurality of individual liquid chambers being in communication with the ejection ports;
an energy generation element that generates energy for ejecting the liquid from the ejection ports, the energy generation element being provided for each of the plurality of individual liquid chambers;
a common liquid chamber that is in communication with the plurality of individual liquid chambers; and
a supply port that supplies the liquid to the individual liquid chambers via the common liquid chamber, the supply port being in communication with the common liquid chamber, wherein,
in a case where, in the arrangement direction, one end of the liquid ejection head is defined as a first end and the other end thereof is defined as a second end, and an individual liquid chamber closest to the first end among the plurality of individual liquid chambers is defined as a first individual liquid chamber, the supply port is located closer to the first end than the first individual liquid chamber.

2. The liquid ejection head according to claim 1, further comprising:
an ejection port forming member in which the ejection ports are formed, the ejection port forming member having an inner wall surface, the inner wall surface including
a first surface that constitutes an end surface on a first-end side among wall surfaces of the first individual liquid chamber,
a second surface that constitutes an end surface on the first-end side among wall surfaces of the common liquid chamber, the second surface being formed on the first-end side relative to the first surface, and
a third surface that connects the first surface to the second surface.

3. The liquid ejection head according to claim 1, wherein
a center line in the arrangement direction of the first individual liquid chamber is located farther from the first end than a center line in the arrangement direction of the supply port.

4. The liquid ejection head according to claim 1, further comprising:
a plurality of the supply ports arranged side by side in the arrangement direction, wherein,
in a case where a supply port closest to the first end among the plurality of supply ports is defined as a first supply port and a supply port adjacent to the first supply port is defined as a second supply port, a distance from a center line of the first individual liquid chamber to a center line of the first supply port in the arrangement direction is not more than one-half of a distance from the center line of the first supply port to a center line of the second supply port in the arrangement direction.

5. The liquid ejection head according to claim 1, further comprising:
a plurality of the supply ports arranged side by side in the arrangement direction, wherein
the plurality of discharge ports are arranged such that a distance between adjacent discharge ports in the arrangement direction is constant, the plurality of supply ports are arranged such that a distance between adjacent supply ports in the arrangement direction is constant, and a ratio of the distance between the adjacent discharge ports to the distance between the adjacent supply ports is in a range of 1:1 to 1:8.

6. The liquid ejection head according to claim 1, further comprising:
a recovery port that recovers the liquid from the individual liquid chambers via the common liquid chamber in a case where a recording operation is performed by the liquid ejection head, the recovery port being located opposite to the supply port relative to the individual liquid chambers in a direction crossing the arrangement direction and closer to the first end than the first individual liquid chamber.

7. The liquid ejection head according to claim 6, further comprising:
a plurality of the recovery ports arranged side by side in the arrangement direction, wherein
the plurality of discharge ports are arranged such that a distance between adjacent discharge ports in the arrangement direction is constant, the plurality of recovery ports are arranged such that a distance between adjacent recovery ports in the arrangement direction is constant, and a ratio of the distance between the adjacent discharge ports to the distance between the adjacent recovery ports is in a range of 1:1 to 1:8.

8. The liquid ejection head according to claim 1, further comprising:
a plurality of the supply ports arranged side by side in the arrangement direction, wherein
in the arrangement direction, a supply port on a second-end side is located closer to the second end than an individual liquid chamber on the second-end side.
